(19) United States
(12) Patent Application Publication
(10) Pub. No.: US 2026/0001559 A1
(43) Pub. Date: Jan. 1, 2026

(54) DETECTION OF YAW INSTABILITIES IN VEHICLE COMBINATIONS

(71) Applicant: VOLVO TRUCK CORPORATION, Göteborg (SE)

(72) Inventors: Umur ERDINC, Göteborg (SE); Mats JONASSON, Partille (SE); Bengt JACOBSON, Mölnlycke (SE)

(73) Assignee: VOLVO TRUCK CORPORATION, Göteborg (SE)

(21) Appl. No.: 18/992,352

(22) PCT Filed: Jul. 15, 2022
(86) PCT No.: PCT/EP2022/069954

§ 371 Date: Jan. 8, 2025

(51) Int. Cl. B60W 40/114; B60W 40/103

(52) U.S. Cl. CPC B60W 40/114; B60W 40/103; B60W 2300/145; B60W 2520/10; B60W 2520/125; B60W 2520/20

(57) ABSTRACT

A method detects a yaw instability in a vehicle combination. The vehicle combination has a tractor unit and at least one trailing unit. The method includes determining a current value of a sideslip angle parameter of at least one unit of the vehicle combination, comparing the current value of the sideslip angle parameter to a threshold, and if the current value of the sideslip angle parameter is beyond the threshold, determining that a yaw instability is present in the vehicle combination.

### FIELD

This disclosure relates to detection of unsafe operation in vehicle combinations. In particular, it relates to detection of yaw instabilities for combinations of at least two vehicle units.

### BACKGROUND

Multi-unit vehicle combinations are prone to different modes of unsafe operation including jack-knifing, trailer swing, rollover and off-tracking. Two of these, jack-knifing and trailer swing, can be grouped under the umbrella of yaw instabilities, as they are predominantly embodied in the yaw behaviour of the tractor and trailing units of a vehicle combination.

Jack-knifing occurs when the tractor unit of a vehicle combination starts to skid sideways in slippery road conditions and the driver is not able to correct the skidding in time with the proper amount of steering. The trailing unit pushes the tractor unit causing the tractor unit to turn around a vertical axis until it hits the trailing unit. Jack-knifing is one of the major sources of accidents in multi-unit vehicle combinations. Trailer swing occurs when the wheels of the trailing unit slip, for example due to slippery road conditions, while the wheels of the tractor unit do not. In this case, the trailing unit starts to swing around the vertical axis. All types of vehicle combinations are susceptible to such instabilities.

These instabilities can be exacerbated by the presence of propulsive elements, for example motors or braking systems, on the trailing unit. Such elements are used increasingly as electric vehicles become more popular. For example, electric motors may be present on some or all axles of the different units. In some instances, a controller of such a vehicle may activate the electric motors of only one axle or unit in order to propel the vehicle. For example, the controller may activate only the electric motors of a trailing unit if the battery of the tractor unit is emptier or if the tractor unit is a conventional tractor unit and the trailing unit is an electric trailer. Electric axles may also be used to capture energy via regenerative braking. A controller may cause only one axle or unit to perform regenerative braking without braking the other axles or units, for example if the battery of one unit is much emptier than the battery of another unit.

Propelling or braking with only one axle or unit may create the conditions for yaw instabilities more readily than conventional ways of propelling and braking. To avoid such situations, it is important to detect such yaw instabilities either in advance or at an early point of onset.

### SUMMARY

This disclosure attempts to solve the problems noted above by providing a method of detecting a yaw instability in a vehicle combination. In particular, a sideslip angle or sideslip angular rate of at least one unit of the vehicle combination can be monitored with respect to a threshold to determine if the vehicle combination is operating in a safe manner. The threshold can be set based on a current operating state of the vehicle combination.

The method allows an upcoming or ongoing yaw instability in a vehicle combination to be detected with high accuracy and at an early stage. The sideslip angle or sideslip angular rate of a given unit gives good certainty on whether a jack-knife or trailer swing is taking place. The method only requires monitoring of a single unit, and does not require any monitoring of the articulation angle, meaning that this finding can be applied to vehicle combinations with trailers lacking sensors. By determining thresholds for safe operation dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided.

According to an aspect, there is provided a method of detecting a yaw instability in a vehicle combination, the vehicle combination comprising a tractor unit and at least one trailing unit, the method comprising determining a current value of a sideslip angle parameter of at least one unit of the vehicle combination, comparing the current value of the sideslip angle parameter to a threshold, and if the current value of the sideslip angle parameter is beyond the threshold, determining that a yaw instability is present in the vehicle combination.

Optionally, the sideslip angle parameter is the sideslip angle or the sideslip angular rate of the at least one unit. Optionally, the method comprises determining the current value of the sideslip angle parameter using one or more sensors on the vehicle combination and/or a vehicle model.

Optionally, the threshold is a deviation from a steady state value of the sideslip angle. Optionally, the threshold is a fixed threshold determined based on a steady state value of the sideslip angle.

Optionally, the threshold is determined based on a current operating state of the vehicle combination. Optionally, the current operating state of the vehicle combination comprises a longitudinal speed of the vehicle combination, a lateral acceleration of the tractor unit, a lateral acceleration of the trailing unit, a road wheel angle of the tractor unit, a road wheel angle of the trailing unit, a road surface friction coefficient and/or a road profile.

Optionally, the threshold for sideslip angle is a deviation from the steady state value of the sideslip angle,

$$Δ {β}_{i}^{threshold} ,$$

is given by:

$$Δ {β}_{i}^{threshold} = A + B \cdot min ( \frac{abs ( {a}_{y , i} )}{C \cdot g} , 1 )$$

Optionally, the threshold deviation for sideslip angle,

$$Δ {β}_{i}^{threshold} ,$$

is given by:

$$Δ {β}_{i}^{threshold} = A + B \cdot min ( \frac{μ}{C} , 1 )$$

Optionally, the threshold deviation for sideslip angle,

$$Δ {β}_{i}^{threshold} ,$$

is given by:

$$Δ {β}_{i}^{threshold} = A + B \cdot min ( max ( γ , - 0.05 ) , + 0.05 )$$

Optionally, the threshold deviation for sideslip angle,

$$Δ {β}_{i}^{threshold} ,$$

is given by:

$$Δ {β}_{i}^{threshold} = A + B \cdot min ( \frac{{v}_{ir}}{C} , 1 )$$

Optionally, the threshold deviation for sideslip angle,

$$Δ {β}_{i}^{threshold} ,$$

is given by:

$$Δ {β}_{i}^{threshold} = A + B \cdot min ( \frac{{δ}_{i}}{C} , 1 )$$

where A, B and C are constants, a_{y,i} is the lateral acceleration of the unit, g is the gravitational acceleration, u is the road surface friction coefficient, γ is the slope of the road, vᵢᵣ is the longitudinal speed of the unit, and δᵢ is the road wheel angle of the unit. Optionally, the constants A, B and C are determined based on experimental data.

Optionally, the method comprises determining that a jack-knife is present in the vehicle combination if the current value of the sideslip angle parameter of the tractor unit is beyond the threshold. Optionally, the method comprises determining that trailer swing is present in the vehicle combination if the current value of the sideslip angle parameter of the trailing unit is beyond the threshold. Optionally, the method comprises determining that a complete spin out is present in the vehicle combination if the current values of the sideslip angle parameter of the tractor unit and the trailing unit are beyond respective thresholds.

According to an aspect, there is provided a computer-readable medium having stored thereon instructions that, when executed by one or more processors cause execution of the method steps.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

Exemplary embodiments of the disclosure shall now be described with reference to the drawings in which:

FIG. 1 shows an example vehicle combination;

FIG. 2A shows jack-knifing of a vehicle combination;

FIG. 2B shows trailer swing in a vehicle combination;

FIG. 3 shows an example unit axis system for modelling a vehicle combination;

FIG. 4A shows a generic kinematic model of two units of a vehicle combination;

FIG. 4B shows a kinematic model of a vehicle combination comprising a tractor unit and a trailing unit;

FIG. 5 is a plot of the sideslip angle of a tractor unit and a trailing unit for a jack knife case;

FIG. 6 is a plot of the sideslip angle of a tractor unit and a trailing unit for a trailer swing case;

FIG. 7 a flow chart illustrating a method of detecting a yaw instability in a vehicle combination;

FIG. 8 is a block diagram illustrating an exemplary computer system in which embodiments of the present disclosure may be implemented.

### SPECIFIC DESCRIPTION

The invention will now be described more fully hereinafter with reference to the accompanying drawings, in which certain aspects of the invention are shown. The invention may, however, be embodied in many different forms and should not be construed as limited to the embodiments and aspects set forth herein; rather, the embodiments are provided by way of example so that this disclosure will be thorough and complete, and will fully convey the scope of the invention to those skilled in the art. Accordingly, it is to be understood that the present invention is not limited to the embodiments described herein and illustrated in the drawings; rather, the skilled person will recognize that many changes and modifications may be made within the scope of the appended claims. Like reference numerals refer to like elements throughout the description.

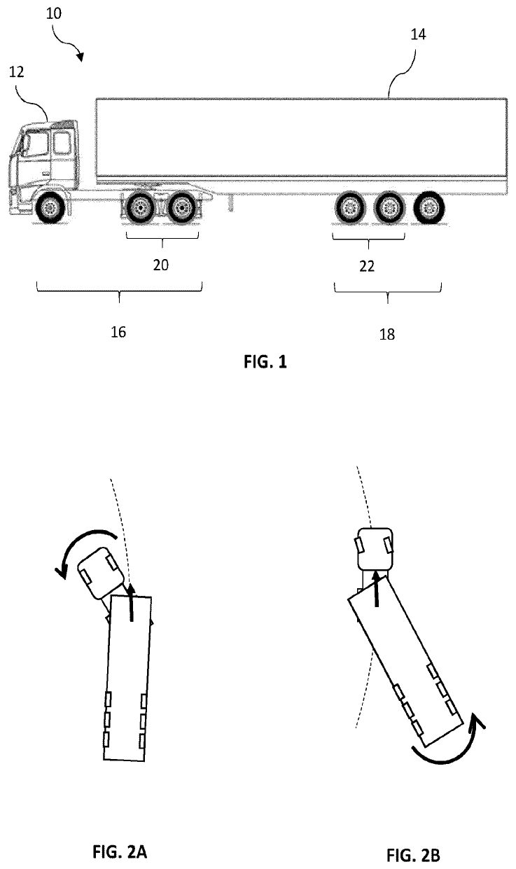

FIG. 1 shows an example vehicle combination 10 of the type considered in this disclosure. The vehicle combination 10 comprises a tractor unit 12 and at least one trailing unit 14. The tractor unit 12 is generally the foremost unit in a vehicle combination, and comprises the cabin for the driver, including steering controls, dashboard displays and the like. Generally, the tractor unit 12 is used to provide propulsion power for the vehicle combination 10. The at least one trailing unit 14 is generally used to store goods that are being transported by the vehicle combination. The at least one trailing unit 14 may be a truck, trailer, dolly and the like. The at least one trailing unit 14 may also provide propulsion to the vehicle combination 10. For example, the trailing unit 14 may comprise one or more electric motors configured to drive one or more axles or individual wheels of the trailing unit 14. A trailing unit 14 without a front axle is known as a semi-trailer.

A vehicle combination 10 may be defined by physical properties of the various units, for example a geometry of each unit and the combination as a whole, a number of axles on each unit, a distance between the axles on each unit, a number of motion support devices (including, for example, electric motors, mechanical service brakes and steering actuators) on each unit, a cornering stiffness on the tyres of each unit, an inertia about a yaw-axis of each unit, an electric motor peak torque output on each unit, an axle load on the axels of each unit.

In the example of FIG. 1, the tractor unit 12 comprises a number of tractor axles 16, and the trailing unit 14 comprises a number of trailer axles 18. At least one of the axles on each unit may be a driven axle, meaning that it is coupled to a propulsion system to drive the vehicle combination 10 forward. The propulsion systems may include traditional propulsion systems coupled to driven axles of the tractor unit 12, and/or electric motors coupled to driven axles of the tractor unit 12 or the trailing unit 14. For example, the three tractor axles 16 may comprise two driven tractor axles 20, and the three trailer axles 18 may comprise two driven trailer axles 22. A unit may be designated by the combination of axles present. In the example of FIG. 1, the vehicle combination 10 comprises a “6×4” tractor unit 12 and a “6×4” trailing unit 14, meaning each unit has six wheels, four of which are driven.

Whilst three tractor axles 16 and three trailer axles 18 are shown, it will be appreciated that any suitable number of axles may be provide on the tractor unit 12 and the at least one trailing unit 14. It will also be appreciated that any number of the tractor axles 16 and/or trailer axles 18 may be driven axles, including zero (i.e. one of the units may include at least one driven axle while the other does not). Furthermore, further trailing units 14 may be provided connected to each other. This gives rise to different types and designations of vehicle combinations.

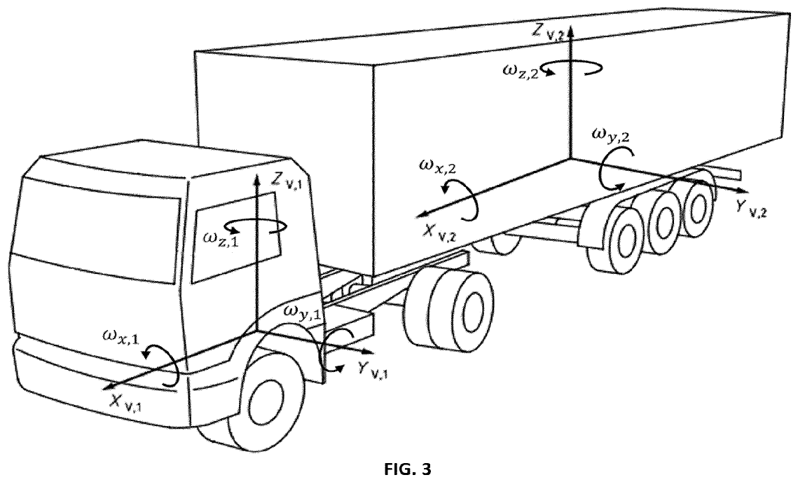

In order to detect yaw instabilities, proper definitions the unsafe behaviour modes are required. The unsafe behaviour modes that are considered as yaw instabilities are in FIGS. 2A and 2B. FIG. 2A shows jack-knifing the wheels of the tractor unit 12 slipping. In particular, the wheels on the two rear axles of the tractor unit 12 slip while the wheels on the trailing unit 14 do not slip, causing a jack-knife. FIG. 2B shows trailer swing due to the wheels of the trailing unit 14 slipping. In particular, the wheels on the trailing unit 14 slip while the wheels on the tractor unit 12 do not slip, causing trailer swing. An unsafe mode where both jack-knifing and trailer swing occur may be known as a complete spin out.

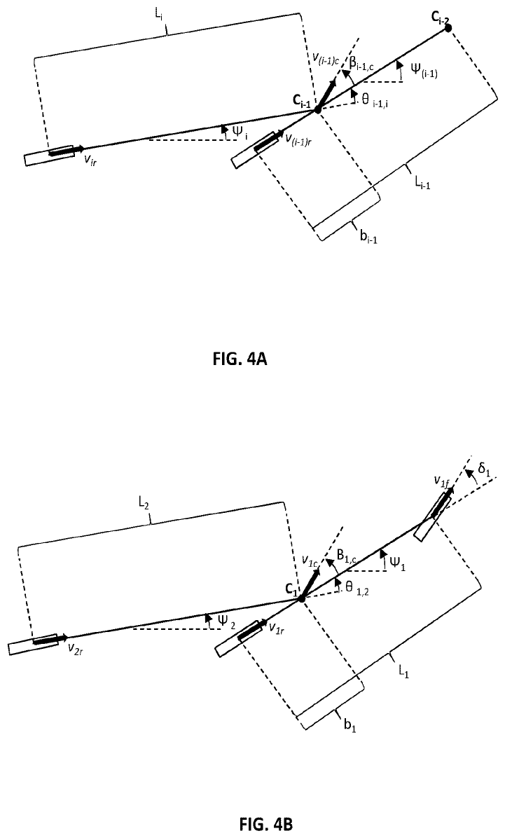

FIGS. 3 and 4 show examples of how the dynamics of a vehicle combination 10 can be modelled. In order to describe motion and dynamics of the different vehicle units a definition of coordinate systems and global forces acting on them is required. For this, the international standard for road vehicles ISO 8855 is used.

As shown in FIG. 3, X_{V,i}, Y_{V,i}, and Z_{V,i} are the unit axis systems where i∈{1, 2, . . . n}, with the tractor unit 12 being unit number 1, and trailing units 14 getting increasingly higher numbers. Whilst only one trailing unit 14 is shown, it will be appreciated that further trailing units may be present in the vehicle combination 10. n is the total number of units of the vehicle combination 10. The rate of deviation around each axis is given by ω. The yaw rate of each unit is its rate of deviation about the Z axis, denoted ω_{z,i}. In the remainder of this disclosure, the yaw rate of a unit will be simply denoted ωᵢ.

Parameters and dimensions are defined per unit i on the vehicle combination 10, as shown in FIGS. 4A and 4B. FIG. 4A is a generic kinematic model of two units i−1 and i of a vehicle combination 10. Each unit has a wheelbase Lᵢ. The coupling point between units i−1 and i is denoted Cᵢ₋₁. A distance between a rear axle of a unit i−1 and the coupling point to the unit i is denoted bᵢ₋₁. Note that point Cᵢ₋₂ is the front axle of tractor in the case that i=2.

The angle between the longitudinal axes of consecutive units is known as the articulation angle θ. In particular, the articulation angle θ between units i and i+1 is given by θ_{i,i+1} (i.e. the articulation angle θ between the tractor unit 12 and the first trailing unit 14 is denoted θ_{1,2}). The rate of change of the articulation angle, known as the articulation angular rate, is denoted by \dot{θ}. The yaw angle of a unit is denoted ψᵢ. The sideslip angle of a unit is denoted βᵢ. β_{i-1,c} is the sideslip angle of unit i−1 at the coupling point. The longitudinal velocity of a unit is taken from a rear axle of the unit and is denoted vᵢᵣ. The units have a road wheel angle δᵢ (shown in FIG. 4B) which is the angle between the direction of the wheels and the longitudinal direction of the unit.

In Error! Reference source not found.B, a kinematic model of a vehicle combination 10 comprising a tractor unit 12 and a trailing unit 14 is shown. The tractor unit has wheelbase L₁ and the trailing unit 14 has wheelbase L₂. The tractor unit 12 and the trailing unit 14 are connected via a moment free articulation point C₁. The distance from the rear axle of the tractor unit 12 to the coupling point C₁ is denoted as b₁. The tractor unit 12 has a front axle velocity denoted v_{if}. The other parameters are given the appropriate subscripts as discussed above. The front axle of the tractor unit 14 is steered with a road wheel angle δ, which is determined by the steering controls of the tractor unit 14.

The vehicle is modelled as a single-track model, i.e., left and right wheels on a given axle are considered together. The real units can have axle groups with several axles, but in the model they are considered together, i.e., the tractor unit 14 is modelled with only one front and one rear wheel and the trailing unit 14 is modelled with only one wheel. The tyres are modelled with no tyre slip, which means that the tyre velocity vectors v₁ᵣ, v_{1f} and v₂ᵣ are directed along the centreline of the tyres.

The inventors have determined that the yaw instabilities shown in FIGS. 2A and 2B can be described by the time response of a sideslip angle parameter, such as the sideslip angle or angular rate, of the units of the vehicle combination. The sideslip angle, β, is the angle between the longitudinal direction and the traveling direction of a unit. It describes the attitude of the vehicle in relation to the circular path during a steady-state cornering. The sideslip angle for a unit i can be defined as:

$${β}_{i} = arctan ( \frac{{v}_{iy}}{{v}_{ix}} )$$

where v_{iy} is the lateral velocity at a point on the unit, and vᵢₓ is the longitudinal velocity at a point on the unit. The point on the unit at which these values are taken may be an axle centre, for example at the rear axle. The side-slip angle, β₁, of the tractor unit 12 can be measured at the centre of the drive axles of the tractor unit 12. The side-slip angle, βᵢ, of the trailing unit 12 can be measured at the centre of the trailer axles of the trailing unit 12.

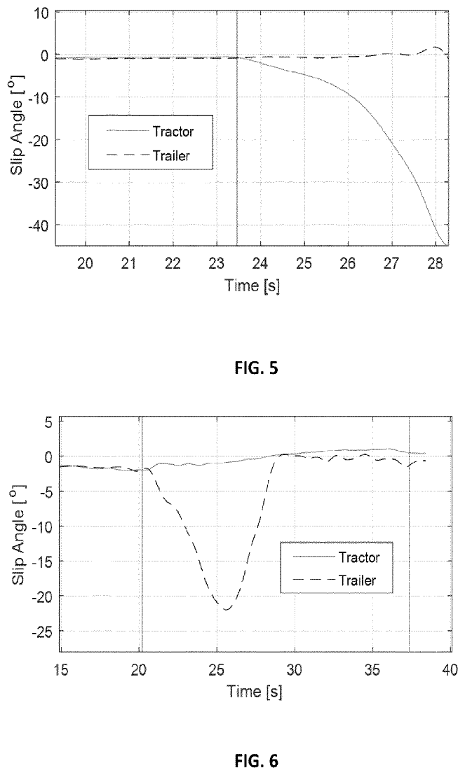

Examples of these time responses are shown in FIGS. 5 and 6. The time responses are based on a model of a vehicle combination 10 comprising a tractor unit 12 and a trailing unit 14. The vehicle combination 10 is protected against a severe jack knife by means of a jack-knife protection cable connected between the tractor unit 12 and the trailing unit 14. The jack-knife protection cables allow maximum of 60° articulation angle, at which point the cable tightens and prevents a catastrophic jack-knife. The time responses in FIGS. 5 and 6 are shown up to the time when the jack knife-cable tightens. For trailer swing, on the other hand, the time responses are shown until the vehicle combination 10 reaches a standstill.

FIG. 5 is a plot of the sideslip angle β₁ of a tractor unit 12 and a trailing unit 14 for a jack knife case. As can be seen, the sideslip angle β₁ of the tractor unit 12 grows significantly from its initial value. Therefore, the sideslip angle β₁ of the tractor unit 12 is a particularly good indicator of a jack-knife. This does not require any monitoring of the trailing unit 14 or the articulation angle θ, meaning that this finding can be applied to vehicle combinations with trailers lacking sensors.

FIG. 6 is a plot of the sideslip angle βᵢ of a tractor unit 12 and a trailing unit 14 for a trailer swing case. As can be seen, the sideslip angle βᵢ of the trailing unit 14 grows significantly from its initial value, before returning to its initial level. Therefore, the sideslip angle βᵢ of the trailing unit 14 is another good indicator of a jack-knife. This does not require any monitoring of the trailing unit 14 or the articulation angle θ, meaning that this finding can be applied to vehicle combinations with trailers lacking sensors.

As can also be seen from FIGS. 5 and 6, the rate of change of the sideslip angle (the sideslip angular rate) of the tractor unit 12 and the trailing unit 14 is approximately constant and non-zero, at least in the early stages of yaw instability. As such, the sideslip angular rate of the units is another good indicator of a yaw instability and can be used to determine the time when it will happen. For example, the sideslip angular rate is near zero for steady state driving, and becomes non-zero (or at least relatively large) at the onset of an instability. Therefore, a threshold can be set that indicates when the sideslip angular rate increases beyond the expected low value, indicating the onset of an instability.

With this in mind, a method is proposed in which the sideslip angle or angular rate of at least one unit of the vehicle combination 10 is monitored with respect to certain limits to determine if the vehicle combination 10 is operating in a safe manner. In particular, thresholds for the sideslip angle or sideslip angular rate of different units can be used to determine whether the vehicle combination 10 is operating safely. The thresholds can be fixed or a function of a current operating state of the vehicle combination.

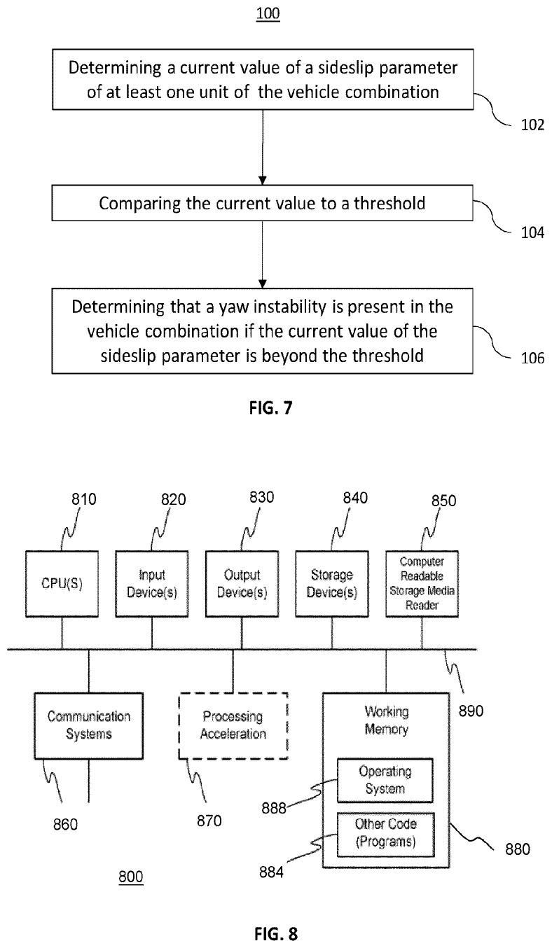

FIG. 7 is a flow chart illustrating a method 100 of detecting a yaw instability in a vehicle combination, such as the vehicle combination 10, comprising a tractor unit 12 and at least one trailing unit 14.

The method 100 comprises, at step 102, determining a current value of a sideslip angle parameter of at least one unit of the vehicle combination is determined. The sideslip angle parameter is the sideslip angle or the sideslip angular rate of the at least one unit. The current value of the sideslip angle parameter can be determined in a number of ways. The current value of the sideslip angle can be determined using one or more sensors on the vehicle combination 10, for example inertial or navigational sensors disposed on the units of the vehicle combination 10. Typically inertial and navigational systems output the sideslip angle with high accuracy. In some examples, signals from an inertial measurement unit (IMU) and a global positioning system (GPS) device may be combined, for example using a Kalman filter. Alternatively, a vehicle model can be used to estimate the sideslip angle. The sideslip angular rate can then be determined from the derivative of the measured or modelled values of the sideslip angle.

At step 104, the current value of the sideslip angle parameter is compared to a threshold. The threshold may be a fixed threshold, determined for example based on model or experimental data, or a variable threshold, determined for example based on the current operating state of the vehicle combination 10. The threshold may be an absolute value or may be a deviation from a modelled or steady state value of the sideslip angle parameter. Sideslip exists in almost all driving conditions, as it is needed to create a lateral force in the tyres. For example, in a steady state driving condition just before braking, the sideslip angle β of a particular unit may be 3° and the sideslip angular rate \dot{β} may be near zero. Therefore, a deviation from these values can indicate whether or not a yaw instability is present. The steady state value can be taken as the value when braking starts, or it can be calculated via a vehicle model as discussed above. To determine a model value, it is required to calculate the lateral velocity at the centre of gravity of the units and use this together with the yaw rate of the unit to calculate the lateral velocity of the unit, and therefore the sideslip angle at any point. This involves solving many equations simultaneously, which can be achieved by linearization.

To determine a fixed threshold, experimental or model data relating to a vehicle combination 10 can be used to determine safe and unsafe operating conditions. This can be done using real tests, computer model simulations, a machine learning model, or other suitable means known in the art. For example, a number of manoeuvres can be logged both with and without yaw instabilities. These can be performed with many different speeds, lateral accelerations, frictions, slopes, load distributions, road wheel angles, etc. These can then be evaluated and the thresholds can be tuned, if possible as a function of vehicle states and/or environmental variables. Alternatively, a machine learning model can be trained to tune the thresholds.

In general, the threshold deviation for the tractor unit 12 may be higher than that for the trailing unit 14 in the case of a jack-knife. The reason for this is that, at the start of a jack-knife, if it is possible to prevent it developing through counter-steering or the like. As such, the driver can prevent the jack-knife as the sense it occurring. If a jack-knife does occur, the sideslip angle grows quickly, meaning it can be sensed at an early stage. For the sideslip angle β, the threshold can be set at, for example, ±5° from the steady state value for the tractor unit 12, and ±3° for the trailing unit 14. For the sideslip angular rate \dot{β}, the threshold can be set at, for example, ±2°/sec. It will be readily envisaged that other values of the threshold may be used dependent on vehicle and driving conditions.

The onset of trailer swing is harder for a driver to sense without checking a rear-view mirror. Furthermore, a longer trailing unit can be more unstable. For example, a 3° deviation from the steady state value may mean 0.5 meters off-tracking for a long trailing unit, meaning it will leave the lane and potentially hit other vehicles or obstacles. Furthermore, the sideslip angle can be stabilised by a decrease in lateral acceleration due to braking. Therefore, example values of the threshold for the sideslip angle β may be ±5° from the steady state value for the tractor unit 12, and ±3° for the trailing unit 14. For the sideslip angular rate \dot{β}, the threshold can be set at, for example, ±2°/sec.

To determine a variable threshold based on the current operating state of the vehicle combination 10, experimental or model data relating to a vehicle combination 10 can be used, as discussed above, to determine safe and unsafe operating conditions as the operating state of the vehicle combination 10 changes. This can be done using real tests, computer model simulations, a machine learning model, or other suitable means known in the art. The threshold can vary with vehicle states such as longitudinal speed v₁ᵣ of the vehicle combination 10, lateral acceleration a_{y} of the tractor unit 12 and/or the at least one trailing unit 14, and road wheel angle δ of the tractor unit 12, a road profile, and/or a road surface friction coefficient μ.

For lateral acceleration, the deviation from the steady state value of the sideslip angle,

$$Δ {β}_{i}^{threshold} ,$$

can be given by:

$$Δ {β}_{i}^{threshold} = A + B \cdot min ( \frac{abs ( {a}_{y , i} )}{C \cdot g} , 1 )$$

where A, B and C are constants, a_{y,i} is the lateral acceleration of the unit, and g is the gravitational acceleration. In particular, A is the deviation from the steady state value of the sideslip angle to be used with zero lateral acceleration, and A+B is the ratio for a C*g lateral acceleration. C it set corresponding to a maximum realistic lateral acceleration. It is noted that the maximum realistic lateral acceleration for heavy vehicles is typically between 0.3 g and 0.4 g. This increases the threshold in a linear manner for increasing lateral acceleration. The value of B can be set as positive or negative dependent on how much sideslip should be allowed for high or low lateral acceleration.

The constants A and B may be determined based on experimental or model data, as discussed above. In one example, for zero lateral acceleration, the threshold can be ±4° for the tractor unit 12, and ±2° for the trailing unit 14 (i.e. A is set at 4 and 2 respectively). For a lateral acceleration of 0.4 g, the threshold can be ±6° for the tractor unit 12, and ±4° for the trailing unit 14 (i.e. A is set at 4 and 2 respectively, while B is set at 2). This means that for higher lateral accelerations, more sideslip is allowed. The constants A and B can be adjusted based on how much sideslip is allowed for different lateral accelerations. For example, B could be set as positive if more sideslip is to be allowed for high lateral accelerations.

When calculating the threshold,

$$Δ {β}_{i}^{threshold} ,$$

for a given unit, the lateral acceleration, a_{y}, may be that of the same unit, or of another unit. For example, it may be advantageous to use the lateral acceleration of a stable unit to detect an instability at the other unit. It may also be advantageous to use the lateral acceleration of the unit having the instability when the instability started. For example, it can be assumed that there is no instability before braking, and so the lateral acceleration of the unit when braking started can be taken. Another alternative is to use the steady state lateral acceleration, a_{y,ss,i′}, which can be given by:

$${a}_{y , ss , i} = \frac{{v}_{i , r}^{2}}{R}$$

where R is the turning radius. It is noted that the longitudinal speed v₁ᵣ of the vehicle combination 10 is taken from a rear axle of the tractor unit 12, as it moves along the longitudinal axis of the vehicle combination 10, whereas the front axle is steered with the road wheel angle δ, and so is not precisely equal to the longitudinal speed of the vehicle combination 10.

For road surface friction coefficient, the deviation from the steady state value of the sideslip angle,

$$Δ {β}_{i}^{threshold} ,$$

can be given by:

$$Δ {β}_{i}^{threshold} = A + B \cdot min ( \frac{μ}{C} , 1 )$$

Here, A is the deviation from the steady state value of the sideslip angle to be used with zero friction (there is no road with zero friction, but it is used here to define the function). A+B is the limit for friction C, and the threshold increases linearly as friction increases. The constants A and B may be determined based on experimental or model data, as discussed above. In one example, for zero road friction, the threshold can be ±4° for the tractor unit 12, and ±2° for the trailing unit 14 (i.e. A is set at 4 and 2 respectively). For higher road surface friction coefficients, higher forces can be generated and so more sideslip is allowed. For a road surface friction coefficient of 1 (e.g. asphalt), the threshold can be ±6° for the tractor unit 12, and ±4° for the trailing unit 14 (i.e. A is set at 4 and 2 respectively, B is set at 2, and C is set at 1). The constants A and B can be adjusted based on how much sideslip is allowed for different road surface friction coefficients.

For road profile, the deviation from the steady state value of the sideslip angle,

$$Δ {β}_{i}^{threshold} ,$$

can be given by:

$$Δ {β}_{i}^{threshold} = A + B \cdot min ( \frac{{v}_{ir}}{C} , 1 )$$

where γ is the slope of the road in percent or radians. Here, A is the deviation from the steady state value of the sideslip angle to be used for a flat road. A+B is the limit for a 5% uphill slope. For a downhill slope of −5%, the limit is A-B. For tractor braking, and trailer propulsion, downhill slopes are riskier, and so the threshold can be smaller for such conditions. For tractor propulsion and trailer braking, uphill slopes are riskier, and so the threshold can be smaller for such conditions.

For longitudinal speed, the deviation from the steady state value of the sideslip angle,

$$Δ {β}_{i}^{threshold} ,$$

can be given by:

$$Δ {β}_{i}^{threshold} = A + B \cdot min ( \frac{{v}_{i r}}{C} , 1 )$$

Here, A is the deviation from the steady state value of the sideslip angle to be used with zero longitudinal speed. A+B is the limit for speed C, and the threshold increases linearly as longitudinal speed increases. The constants A and B may be determined based on experimental or model data, as discussed above. In one example, for zero longitudinal speed, the threshold can be ±4° for the tractor unit 12, and ±2° for the trailing unit 14 (i.e. A is set at 4 and 2 respectively). For a longitudinal speed of 10 m/s (36 kph), the threshold can be ±6° for the tractor unit 12, and ±4° for the trailing unit 14 (i.e. A is set at 4 and 2 respectively, B is set at 2, and C is set at 10). The constants A and B can be adjusted based on how much sideslip is allowed for different longitudinal speeds.

For road wheel angle, the deviation from the steady state value of the sideslip angle,

$$Δ {β}_{i}^{threshold} ,$$

can be given by:

$$Δ {β}_{i}^{threshold} = A + B \cdot min ( \frac{{δ}_{i}}{C} , 1 )$$

Here, A is the deviation from the steady state value of the sideslip angle to be used with zero road wheel angle. A+B is the limit for road wheel angle C, and the threshold increases linearly as road wheel angle increases. The constants A and B may be determined based on experimental or model data, as discussed above. In one example, for zero road wheel angle, the threshold can be ±4° for the tractor unit 12, and ±2° for the trailing unit 14 (i.e. A is set at 4 and 2 respectively). For a road wheel angle of 10°, the threshold can be ±6° for the tractor unit 12, and ±4° for the trailing unit 14 (i.e. A is set at 4 and 2 respectively, B is set at 2, and C is set at 10). The constants A and B can be adjusted based on how much sideslip is allowed for different road wheel angles.

A variable threshold for the sideslip angular rate can be determined by taking the derivative of the sideslip angle. A filter such as a Kalman filter can be used to remove noise with a vehicle and tyre model to better estimate all the states and noise free.

It will be appreciated that the thresholds described above can be used individually or in combination. This may be implemented as a look up table, a machine learning model, or a function, such as a linear or quadratic function of the variables.

By determining thresholds for safe operation dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided.

Returning to FIG. 7, at step 106, if the current value of the sideslip angle parameter is beyond the threshold, it is determined that a yaw instability is present in the vehicle combination. As shown in FIGS. 5 and 6, the sideslip angle grows significantly when a yaw instability is present. Therefore, the threshold can be set as a deviation from a steady state value, and a yaw instability can be detected when it exceeds the threshold. If the current value is within the threshold deviation, then it is determined that the vehicle combination 10 is operating safely. Therefore, to detect an upcoming or ongoing yaw instability, one can simply monitor the sideslip angle.

Dependent on which unit is monitored, different modes of yaw instability can be determined. For example, if the current value of the sideslip angle parameter of the tractor unit 12 is beyond the threshold, it can be determined that a jack-knife is present in the vehicle combination 10. Similarly, if the current value of the sideslip angle parameter of the trailing unit 14 is beyond the threshold, it can be determined that trailer swing is present in the vehicle combination 10. Where values from both types of unit are used, a complete spin out can be detected.

The method 100 allows an upcoming or ongoing yaw instability in a vehicle combination to be detected with high accuracy and at an early stage. The sideslip angle or sideslip angular rate of a given unit gives good certainty on whether a jack-knife or trailer swing is taking place. By determining a threshold for the sideslip angle and angular rate dynamically, based on a current operating state of the vehicle combination, a more robust and responsive detection method is provided.

A tyre model can be used in combination with the methods disclosed above. The tyre model can be that disclosed in the Vehicle Dynamics Compendium from Bengt Jacobson et al, Vehicle Dynamics Group, Division Vehicle and Autonomous Systems, Department of Mechanics and Maritime, Chalmers University of Technology, www.chalmers.se. For example, the tyre model may take into account the cornering stiffness of the tyres of the vehicle combination, which is a value defining tires how much lateral force is created for a certain sideslip angle of the tyre.

FIG. 8 is a block diagram illustrating an exemplary computer system 800 in which embodiments of the present disclosure may be implemented. This example illustrates a computer system 800 such as may be used, in whole, in part, or with various modifications, to provide the functions of the disclosed system. For example, various functions may be controlled by the computer system 800, including, merely by way of example, simulating, determining, classifying, receiving, etc.

The computer system 800 is shown comprising hardware elements that may be electrically coupled via a bus 890. The hardware elements may include one or more central processing units 810, one or more input devices 820 (e.g., a mouse, a keyboard, etc.), and one or more output devices 830 (e.g., a display device, a printer, etc.). The computer system 800 may also include one or more storage devices 840. By way of example, the storage devices 840 may be disk drives, optical storage devices, solid-state storage device such as a random-access memory (“RAM”) and/or a read-only memory (“ROM”), which can be programmable, flash-updateable and/or the like.

The computer system 800 may additionally include a computer-readable storage media reader 850, a communications system 860 (e.g., a modem, a network card (wireless or wired), an infra-red communication device, Bluetooth™ device, cellular communication device, etc.), and a working memory 880, which may include RAM and ROM devices as described above. In some embodiments, the computer system 800 may also include a processing acceleration unit 870, which can include a digital signal processor, a special-purpose processor and/or the like.

The computer-readable storage media reader 850 can further be connected to a computer-readable storage medium, together (and, optionally, in combination with the storage devices 840) comprehensively representing remote, local, fixed, and/or removable storage devices plus storage media for temporarily and/or more permanently containing computer-readable information. The communications system 860 may permit data to be exchanged with a network, system, computer and/or other component described above.

The computer system 800 may also comprise software elements, shown as being currently located within the working memory 880, including an operating system 888 and/or other code 884. It should be appreciated that alternative embodiments of a computer system 800 may have numerous variations from that described above. For example, customised hardware might also be used and/or particular elements might be implemented in hardware, software (including portable software, such as applets), or both. Furthermore, connection to other computing devices such as network input/output and data acquisition devices may also occur.

Software of the computer system 800 may include code 884 for implementing any or all of the function of the various elements of the architecture as described herein. For example, software, stored on and/or executed by a computer system such as the system 800, can provide the functions of the disclosed system. Methods implementable by software on some of these components have been discussed above in more detail.

1. A method of detecting a yaw instability in a vehicle combination, the vehicle combination comprising a tractor unit and at least one trailing unit, the method comprising:
determining a current value of a sideslip angle parameter of at least one unit of the vehicle combination;
comparing the current value of the sideslip angle parameter to a threshold; and
if the current value of the sideslip angle parameter is beyond the threshold, determining that a yaw instability is present in the vehicle combination;
wherein the threshold is determined based on a current operating state of the vehicle combination, wherein the current operating state of the vehicle combination comprises a longitudinal speed of the vehicle combination, a lateral acceleration of the tractor unit, a lateral acceleration of the trailing unit, a road wheel angle of the tractor unit, a road wheel angle of a trailing unit, a road surface friction coefficient and/or a road profile.

2. The method of claim 1, wherein the sideslip angle parameter is the sideslip angle or the sideslip angular rate of the at least one unit.

3. The method of claim 1, comprising determining the current value of the sideslip angle parameter using one or more sensors on the vehicle combination and/or a vehicle model.

4. The method of claim 1, wherein the threshold is a deviation from a steady state value of the sideslip angle.

5-7. (canceled)

8. The method of claim 1, wherein the threshold for sideslip angle is a deviation from the steady state value of the sideslip angle,
$$Δ {β}_{i}^{threshold} ,$$
given by:
$$Δ {β}_{i}^{threshold} = A + B \cdot min ( \frac{abs ( {a}_{y , i} )}{C \cdot g} , 1 )$$
where A, B and C are constants, a_{y,i} is the lateral acceleration of the unit, and g is the gravitational acceleration.

9. The method of claim 1, wherein the threshold for sideslip angle is a deviation from the steady state value of the sideslip angle,
$$Δ {β}_{i}^{threshold} ,$$
given by:
$$Δ {β}_{i}^{threshold} = A + B \cdot min ( \frac{μ}{C} , 1 )$$
where μ is the road surface friction coefficient.

10. The method of claim 1, wherein the threshold for sideslip angle is a deviation from the steady state value of the sideslip angle,
$$Δ {β}_{i}^{threshold} ,$$
given by:
$$Δ {β}_{i}^{threshold} = A + B \cdot min ( max ( γ , - 0.05 ) , + 0.05 )$$
where γ is the slope of the road.

11. The method of claim 1, wherein the threshold for sideslip angle is a deviation from the steady state value of the sideslip angle,
$$Δ {β}_{i}^{threshold} ,$$
given by:
$$Δ {β}_{i}^{threshold} = A + B \cdot min ( \frac{{v}_{i r}}{C} , 1 )$$
where vᵢᵣ is the longitudinal speed of the unit.

12. The method of claim 1, wherein the threshold for sideslip angle is a deviation from the steady state value of the sideslip angle,
$$Δ {β}_{i}^{threshold} ,$$
given by:
$$Δ {β}_{i}^{threshold} = A + B \cdot min ( \frac{{δ}_{i}}{C} , 1 )$$
where δᵢ is the road wheel angle of the unit.

13. The method of claim 8, wherein the constants A, B and C are determined based on experimental data.

14. The method of claim 1, comprising determining that a jack-knife is present in the vehicle combination if the current value of the sideslip angle parameter of the tractor unit is beyond the threshold.

15. The method of claim 1, comprising determining that trailer swing is present in the vehicle combination if the current value of the sideslip angle parameter of the trailing unit is beyond the threshold.

16. A non-transitory computer-readable medium having stored thereon instructions that, when executed by one or more processors cause execution of the method steps according to claim 1.
